(19) United States
(12) Patent Application Publication
(10) Pub. No.: US 2018/0375696 A1
(43) Pub. Date: Dec. 27, 2018

(54) APPARATUS AND METHOD FOR CODEWORD-BASED SCRAMBLING OF DATA

(71) Applicant: QUALCOMM Incorporated, San Diego, CA (US)

(72) Inventors: Bilal SADIQ, Basking Ridge, NJ (US); Navid ABEDINI, Raritan, NJ (US); Xiao Feng WANG, San Diego, CA (US); Haitong SUN, Cupertino, CA (US); Juergen CEZANNE, Ocean Township, NJ (US); Muhammad Nazmul ISLAM, Edison, NJ (US); Sundar SUBRAMANIAN, San Diego, CA (US); Alberto RICO ALVARINO, San Diego, CA (US)

(21) Appl. No.: 16/014,492

(22) Filed: Jun. 21, 2018

Related U.S. Application Data
(60) Provisional application No. 62/525,026, filed on Jun. 26, 2017.
(60) Provisional application No. 62/587,208, filed on Nov. 16, 2017.

(51) Int. Cl. H04L 25/03; H04L 1/00

(52) U.S. Cl. CPC H04L 25/03866; H04L 1/0046

(57) ABSTRACT

Aspects of the present disclosure include systems and methods that transmit masked data by designating one or more selected bits in a bit stream containing data bits, selecting a mask for the bit stream based on the one or more selected bits, masking the bit stream without altering the one or more selected bits, encoding the masked bit stream into one or more codewords, and transmitting the one or more codewords.

### CROSS-REFERENCE TO RELATED APPLICATIONS

This application claims the benefit of U.S. Provisional Application Ser. No. 62/525,026, entitled “Apparatus and Method of Codeword-Based Scrambling of Data” and filed on Jun. 26, 2017, and U.S. Provisional Application Ser. No. 62/587,208, entitled “Apparatus and Method of Codeword-Based Scrambling of Data” and filed on Nov. 16, 2017, the contents of which are expressly incorporated in their entirety.

### BACKGROUND

Aspects of the present disclosure relate generally to wireless communication networks, and more particularly, to the scrambling and masking of data to reduce interference.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as new radio (NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in NR communications technology and beyond may be desired.

For example, in NR communications, physical broadcast channel (PBCH) payload may include a synchronization signal (SS) block index and/or burst-set index, and there are multiple SS blocks and burst-sets over BCH transmission time interval (TTI). These indices increment in similar fashion for multiple cell, and thus even though data changes from SS block to SS block, the interference is not randomized. To minimize interference, transmission over a shared medium, such as wireless or cellular, is often scrambled with transmitter ID, receiver ID, and/or link ID dependent scrambling sequences, where the scrambling is applied to the coded bits. Conventional communication systems scramble transmitted coded bits using a pseudo-random sequence to minimize interference. This scrambling creates interference randomization, particularly useful for repeated transmissions, interference whitening, and may also be used to convey information thru the selection of scrambling sequence from a multitude of available sequences. For conventional pseudo-random scrambling, in scenarios where the transmitter chooses a scrambling sequence from amongst a number of sequences and the UE is unaware of the selection, a UE would need to try multiple hypotheses for descrambling and decoding the data bits. However, this may increase computational load of the user equipment (UE) when decoding the received codeword(s) because the user equipment may utilize an incorrect sequence to reverse the scrambled bits. Therefore, improvements in masking/scrambling data bits prior to transmission are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods that transmit masked data by designating one or more selected bits in a bit stream containing data bits, selecting a mask for the bit stream based on the one or more selected bits, masking the bit stream without altering the one or more selected bits, encoding the masked bit stream into one or more codewords, and transmitting the one or more codewords.

Some aspects of the present disclosure include systems that transmit masked data by designating one or more selected bits in a bit stream containing data bits, selecting a mask for the bit stream based on the one or more selected bits, masking the bit stream without altering the one or more selected bits, encoding the masked bit stream into one or more codewords, and transmitting the one or more codewords.

Certain aspects of the present disclosure include computer-readable media that transmit masked data by designating one or more selected bits in a bit stream containing data bits, selecting a mask for the bit stream based on the one or more selected bits, masking the bit stream without altering the one or more selected bits, encoding the masked bit stream into one or more codewords, and transmitting the one or more codewords.

In an aspect, the present disclosure includes methods that receive one or more codewords by receiving the one or more codewords, decoding the one or more codewords into a masked bit stream having one or more selected bits, and unmasking the masked bit stream based on a value of one or more selected bits to obtain an unmasked bit stream containing data bits.

In some aspects, the present disclosure includes systems that receive one or more codewords by receiving the one or more codewords, decoding the one or more codewords into a masked bit stream having one or more selected bits, and unmasking the masked bit stream based on a value of one or more selected bits to obtain an unmasked bit stream containing data bits.

In certain aspects, the present disclosure includes computer readable media that receive one or more codewords by receiving the one or more codewords, decoding the one or more codewords into a masked bit stream having one or more selected bits, and unmasking the masked bit stream based on a value of one or more selected bits to obtain an unmasked bit stream containing data bits.

Aspects of the present disclosure include methods that transmit masked data by designating two or more selected bits in a bit stream containing data bits, wherein the two or more selected bits include a first subset of the two or more selected bits and a second subset of the two or more selected bits, selecting, based on the first subset of the two or more selected bits, a first component sequence, selecting, based on the second subset of the two or more selected bits, a second component sequence, combining the first component sequence and the second component sequence into a mask, masking the bit stream using the mask without altering the two or more selected bits of the bit stream, encoding the masked bit stream into one or more codewords, and transmitting the one or more codewords to the one or more UEs.

Certain aspects of the present disclosure include systems that transmit masked data by designating two or more selected bits in a bit stream containing data bits, wherein the two or more selected bits include a first subset of the two or more selected bits and a second subset of the two or more selected bits, selecting, based on the first subset of the two or more selected bits, a first component sequence, selecting, based on the second subset of the two or more selected bits, a second component sequence, combining the first component sequence and the second component sequence into a mask, masking the bit stream using the mask without altering the two or more selected bits of the bit stream, encoding the masked bit stream into one or more codewords, and transmitting the one or more codewords to the one or more UEs.

Some aspects of the present disclosure include computer readable media that transmit masked data by designating two or more selected bits in a bit stream containing data bits, wherein the two or more selected bits include a first subset of the two or more selected bits and a second subset of the two or more selected bits, selecting, based on the first subset of the two or more selected bits, a first component sequence, selecting, based on the second subset of the two or more selected bits, a second component sequence, combining the first component sequence and the second component sequence into a mask, masking the bit stream using the mask without altering the two or more selected bits of the bit stream, encoding the masked bit stream into one or more codewords, and transmitting the one or more codewords to the one or more UEs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example of a wireless communication network including at least one user equipment (UE);

FIG. 2 is a schematic diagram of an example user equipment;

FIG. 3 is a schematic diagram of an example base station;

FIG. 4 is an example of a schematic diagram showing masked codeword(s) transmission between a base station and a UE;

FIG. 5 is an example of a flowchart of a method for transmitting masked codewords;

FIG. 6 is an example of a flowchart of a method for receiving masked codewords;

FIG. 7 is another example of a flowchart of a method for transmitting masked data bits; and

FIG. 8 is an example of timing information bitfields.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

It should be noted that the techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to 5G networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

In an aspect, the present disclosure relates to interference randomization while minimizing the decoding process. In particular, the base station masks data bits before encoding masked bits into one or more codewords. The masking process includes selecting a mask sequence that does not modify one or more selected bits. For example, the base station selects the mask based on the one or more selected bits. After generating the one or more codewords, the base station transmits the codeword(s) to the UE. The UE decodes the one or more codewords, and relies on the unmodified one or more selected bits to identify the appropriate unmasking sequence to unmask the masked data bits. The masking of data bits before encoding obviates the step of blind decoding.

Specifically, the methods and systems discussed in the present disclosure perform decoding without first descrambling. The transmission of properly encoded codewords minimizes the amount of resources the UE has to utilize on repeatedly decoding received signals. Since the descrambling of decoded data and/or checking cyclic redundancy check (CRC) consume less resources than decoding, systems and methods of the present disclosure reduce the overall resources utilized by the UE to obtain data bits from the base station.

Further, the selected bits may be packed with timing bits that change from one transmission to the next while the mask remains cell-specific. The mask changes the non-selected bits in a cell-specific manner and these bits otherwise would have stayed constant in PBCH over multiple transmissions. As a result of the mask, the payload of the PBCH may be changed in a cell specific manner to obtain interference randomization.

In another aspect, the present disclosure relates to interference randomization while minimizing and/or reducing the decoding process. In particular, a base station masks data bits before encoding the masked bits into one or more codewords. The masking process includes selecting a mask that does not modify two or more selected bits. For example, the base station selects the mask based on the one or more selected bits. After generating the one or more codewords, the base station transmits the one or more codewords to the UE. The UE decodes the one or more codewords, and relies on the unmodified two or more selected bits to identify the appropriate unmasking sequence to unmask the masked data bits. The masking of data bits before encoding reduces the amount of blind decoding.

Specifically, the methods and systems discussed in the present disclosure perform decoding without first descrambling. The transmission of one or more properly encoded codewords minimizes the amount of resources that a UE utilizes for repeatedly decoding received signals. Since the descrambling of decoded data consume less resources than decoding, systems and methods of the present disclosure reduce the overall resources utilized by the UE to obtain data bits from the base station.

Further, the selected bits may be packed with timing bits that change from one transmission to the next transmission while the mask remains cell-specific. The mask changes the non-selected bits in a cell-specific manner and these bits stays constant in PBCH over multiple transmissions. As a result of the mask, the payload of the PBCH may be changed in a cell specific manner to obtain interference randomization.

Mathematically, the vector b≡(b₁, b₂, . . . , b_{N})^{T} denotes the N-bit long column vector of data bits, [symbol] ≡{1, 2, . . . , N} and N*⊂N is a subset of one or more selected bits locations containing |N*|<N bits, where set N* contains the location of the one or more selected bits that will be used to determine data-dependent mask and/or scrambling. Bits at locations in N* will not be masked. Bit selection operator S_{N}* returns a vector of bits from locations in N*. Particularly, b*=S_{N}* b returns vector b*=(bₙ, n∈N*)^{T} constructed from the selected bits. G denotes the tall generator matrix of the code. That is, c(b)=G·b is the codeword for data bits b.

Here, m(b*)=(m₁, m₂, . . . , m_{N})^{T} may be a b*-dependent N-bit masking sequence such that mₙ=0 for n∈N*. The vector b*=S_{N}*b is the vector of the selected bits. The masking sequence may further depend on an identification (ID), denoted as D, such as cell ID, UE ID, or link ID. Mathematically, the masking sequence may be represented as m(b*, D). With each cell having a unique cell ID, when the UE receives multiple transmissions across two cells with different IDs, even if the locations of the one or more selected bits are identical for each of the multiple transmissions, the masking sequence can still be made distinct by virtue of the dependence on cell ID. The masking sequence may be a pseudo-random sequence, such as a Gold sequence, initialized by seed=nonlinear_function(b*, D). Further, the masking sequence may be obtained from a longer pseudo-random sequence, such as a Gold sequence, initialized by seed=D, and b* used to determine which part of the longer sequence to pick as masking sequence. A high degree of randomness may be expressed as m(b*(1), D(1))+m (b*(1), D(2))≠m (b*(2), D(1))+m (b*(2), D(2)), for D(1)≠D(2) and b*(1)≠b*(2).

Mathematically, a vector with cyclic redundancy check (CRC) encoding may be defined as b_{CRC}=G_{CRC}·b, where b includes data bits without the CRC appended. The obtained codeword then is c=G·(b_{CRC}+m(b_{CRC}*)).

The encoded codeword(s) may be represented as c=G·(b+m(b*)) and G=G_{INNER}G_{OUTER}, where G_{INNER} may be an encoding algorithm and G_{OUTER} may be a CRC code. Mathematically, this is equivalent to scrambling of the codeword where the scrambling of the codeword(s) may be represented as c=G·(b+m(b*))=G·b+G·m(b*)=c(b)+G·m(b*), G·m(b*) being the scrambling sequence that is itself a codeword.

Alternatively, if intercell interference randomization is required when the selected (timing) bits change, then the mask must satisfy the condition, m (b*(1), D(1))+m(b*(1), D(2))=m(b*(2), D(1))+m(b*(2), D(2)), for all D(1)≠D(2) and b*(1)≠b*(2).

Under certain conditions, soft combining multiple receptions—each possibly having different timing bits and different mask/scrambling sequence—may require a UE to test multiple hypotheses and thus attempt blind decoding. Sometimes, a network may sacrifice slightly on intercell interference randomization in order to reduce soft combining complexity. Specifically, out of the P-choose-2 pairs of selected bit vectors (i.e., b*(1) and b*(2)), where P denotes the number of distinct values the selected bits vector b* can take, there may be a subset of pairs of selected bits vectors (i.e., b*(1) and b*(2)) that do not satisfy the above equation.

Mathematically, the masking sequence remains a function of the selected bits b* and an ID D. The selected bits b* are now split into two components, denoted as b⁽¹⁾* and b⁽²⁾*. That is, some of the selected bits are contained in vector b⁽¹⁾* while the other selected bit are contained in vector b⁽²⁾*. A first component sequence depends on the first selected bits component (i.e. a subset of the selected bits) b⁽¹⁾* and ID D, denoted as m⁽¹⁾(b⁽¹⁾*, D) and a second component sequence depends on the second selected bits component b⁽²⁾*, and ID D, denoted as m⁽²⁾(b⁽²⁾*, D). The masking sequence m(b*,D) is a function of the first component sequence m⁽¹⁾(b⁽¹⁾*, D) and the second component sequence m⁽²⁾(b⁽²⁾*, D). Specifically, the function is ‘xor’, i.e., m(b* ,D)=m⁽¹⁾(b⁽¹⁾*, D)+m⁽²⁾(b⁽²⁾*, D). The masking sequence is 0 at the selected bit locations. This can be achieved by requiring both the first and second component sequences to satisfy mₙ⁽¹⁾=mₙ⁽²⁾=0 for n∈ [symbol] *, or more generally, mₙ⁽¹⁾=mₙ⁽²⁾ for n∈ [symbol] .

In an example, a first subset of bits of a first seed is determined by b⁽¹⁾* and D, and a second subset of bits of a second seed is determined by b⁽²⁾* and D, and then the masking sequence is generated by initializing a pseudo-random sequence generator with the seed. If the generated sequence is an affine function of the seed—as is the case with a Gold sequence generator—then this example is actually identical to the method described above. Since the generated sequence is affine in seed, the generated sequence can be written as xor of two sequences where the first sequence depends on the first subset of bits of the seed (and thus on b⁽¹⁾* and D) and is independent of b⁽²⁾*, and the second sequence depends on the second subset of bits of the seed (and thus on b⁽²⁾* and D) and is independent of b⁽¹⁾*.

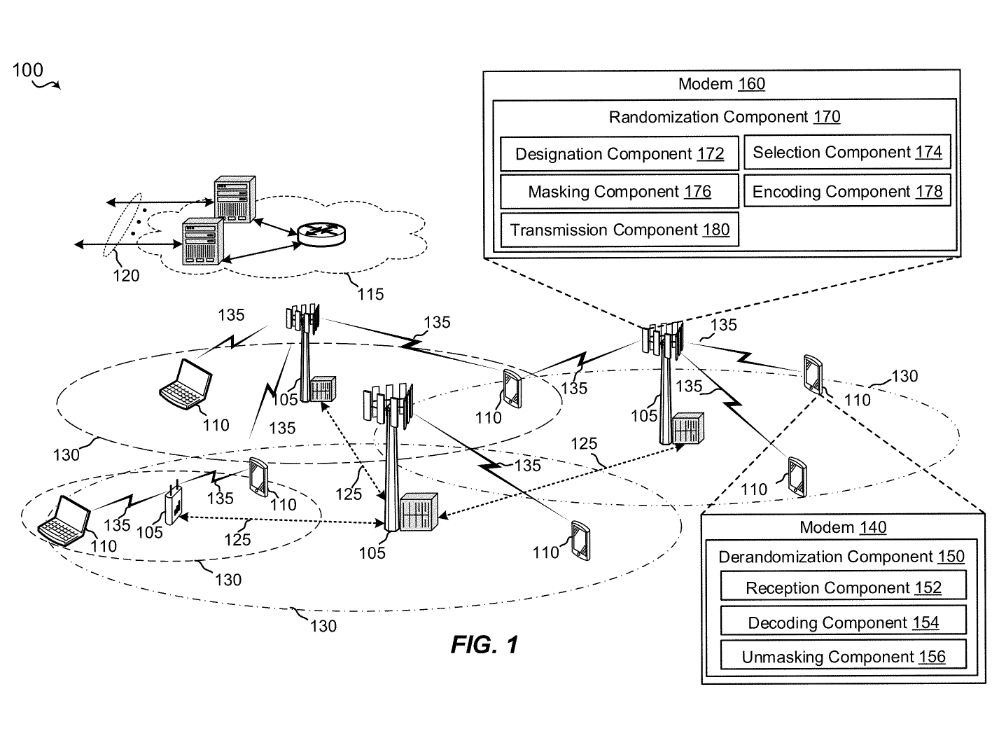

Referring to FIG. 1, in accordance with various aspects of the present disclosure, a wireless communication network 100 includes at least one UE 110 with a modem 140 having a derandomization component 150 that unmasks a scrambled data stream. Further, wireless communication network 100 includes at least one base station 105 with a modem 160 having a randomization component 170 that masks a data stream.

The modem 160 may be configured to communicate with other base stations 105 and UEs 110 via a cellular network or other wireless and wired networks. The modem 140 may be configured to communicate via a cellular network, a Wi-Fi network, or other wireless and wired networks. The modems 140, 160 may receive and transmit data packets.

In some implementations, the randomization component 170 of the base station 105 includes a designation component 172, a selection component 174, a masking component 176, an encoding component 178, and a transmission component 180. The designation component 172 determines the selected bits among the data bits. The selection component 174 chooses an appropriate mask for masking the data bits. The masking component 176 applies the selected mask to the data bits. The application of the mask may alter the values of the data bits. The encoding component 178 encodes the masked data bits into codewords. The transmission component 180 transmits codewords to UEs 110 and/or base stations 105.

In some implementations, the derandomization component 150 of the UE 110 includes a reception component 152, a decoding component 154, and an unmasking component 156. The reception component 152 receives codewords transmitted by base stations 105. The decoding component 154 decodes the encoded codewords, and the unmasking component 156 unmasks the masked data bits to recover the data bits.

The wireless communication network 100 may include one or more base stations 105, one or more UEs 110, and a core network 115. The core network 115 may provide user authentication, access authorization, tracking, internet protocol (IP) connectivity, and other access, routing, or mobility functions. The base stations 105 may interface with the core network 115 through backhaul links 120 (e.g., S1, etc.). The base stations 105 may perform radio configuration and scheduling for communication with the UEs 110, or may operate under the control of a base station controller (not shown). In various examples, the base stations 105 may communicate, either directly or indirectly (e.g., through core network 115), with one another over backhaul links 125 (e.g., X1, etc.), which may be wired or wireless communication links.

The base stations 105 may wirelessly communicate with the UEs 110 via one or more base station antennas. Each of the base stations 105 may provide communication coverage for a respective geographic coverage area 130. In some examples, the base stations 105 may be referred to as a base transceiver station, a radio base station, an access point, an access node, a radio transceiver, a NodeB, eNodeB (eNB), gNB, Home NodeB, a Home eNodeB, a relay, or some other suitable terminology. The geographic coverage area 130 for a base station 105 may be divided into sectors or cells making up only a portion of the coverage area (not shown). The wireless communication network 100 may include base stations 105 of different types (e.g., macro base stations or small cell base stations, described below). Additionally, the plurality of base stations 105 may operate according to different ones of a plurality of communication technologies (e.g., 5G (New Radio or “NR”), fourth generation (4G)/LTE, 3G, Wi-Fi, Bluetooth, etc.), and thus there may be overlapping geographic coverage areas 130 for different communication technologies.

In some examples, the wireless communication network 100 may be or include one or any combination of communication technologies, including a NR or 5G technology, a Long Term Evolution (LTE) or LTE-Advanced (LTE-A) or MuLTEfire technology, a Wi-Fi technology, a Bluetooth technology, or any other long or short range wireless communication technology. In LTE/LTE-A/MuLTEfire networks, the term evolved node B (eNB) may be generally used to describe the base stations 105, while the term UE may be generally used to describe the UEs 110. The wireless communication network 100 may be a heterogeneous technology network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may generally cover a relatively large geographic area (e.g., several kilometers in radius) and may allow unrestricted access by UEs 110 with service subscriptions with the network provider.

A small cell may include a relative lower transmit-powered base station, as compared with a macro cell, that may operate in the same or different frequency bands (e.g., licensed, unlicensed, etc.) as macro cells. Small cells may include pico cells, femto cells, and micro cells according to various examples. A pico cell, for example, may cover a small geographic area and may allow unrestricted access by UEs 110 with service subscriptions with the network provider. A femto cell may also cover a small geographic area (e.g., a home) and may provide restricted access and/or unrestricted access by UEs 110 having an association with the femto cell (e.g., in the restricted access case, UEs 110 in a closed subscriber group (CSG) of the base station 105, which may include UEs 110 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The communication networks that may accommodate some of the various disclosed examples may be packet-based networks that operate according to a layered protocol stack and data in the user plane may be based on the IP. A user plane protocol stack (e.g., packet data convergence protocol (PDCP), radio link control (RLC), MAC, etc.), may perform packet segmentation and reassembly to communicate over logical channels. For example, a MAC layer may perform priority handling and multiplexing of logical channels into transport channels. The MAC layer may also use hybrid automatic repeat/request (HARQ) to provide retransmission at the MAC layer to improve link efficiency. In the control plane, the RRC protocol layer may provide establishment, configuration, and maintenance of an RRC connection between a UE 110 and the base stations 105. The RRC protocol layer may also be used for core network 115 support of radio bearers for the user plane data. At the physical (PHY) layer, the transport channels may be mapped to physical channels.

The UEs 110 may be dispersed throughout the wireless communication network 100, and each UE 110 may be stationary or mobile. A UE 110 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 110 may be a cellular phone, a smart phone, a personal digital assistant (PDA), a wireless modem, a wireless communication device, a handheld device, a tablet computer, a laptop computer, a cordless phone, a smart watch, a wireless local loop (WLL) station, an entertainment device, a vehicular component, a customer premises equipment (CPE), or any device capable of communicating in wireless communication network 100. Additionally, a UE 110 may be Internet of Things (IoT) and/or machine-to-machine (M2M) type of device, e.g., a low power, low data rate (relative to a wireless phone, for example) type of device, that may in some aspects communicate infrequently with wireless communication network 100 or other UEs. A UE 110 may be able to communicate with various types of base stations 105 and network equipment including macro eNBs, small cell eNBs, macro gNBs, small cell gNBs, relay base stations, and the like.

UE 110 may be configured to establish one or more wireless communication links 135 with one or more base stations 105. The wireless communication links 135 shown in wireless communication network 100 may carry uplink (UL) transmissions from a UE 110 to a base station 105, or downlink (DL) transmissions, from a base station 105 to a UE 110. The downlink transmissions may also be called forward link transmissions while the uplink transmissions may also be called reverse link transmissions. Each wireless communication link 135 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. In an aspect, the wireless communication links 135 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2). Moreover, in some aspects, the wireless communication links 135 may represent one or more broadcast channels.

In some aspects of the wireless communication network 100, base stations 105 or UEs 110 may include multiple antennas for employing antenna diversity schemes to improve communication quality and reliability between base stations 105 and UEs 110. Additionally or alternatively, base stations 105 or UEs 110 may employ multiple input multiple output (MIMO) techniques that may take advantage of multi-path environments to transmit multiple spatial layers carrying the same or different coded data.

Wireless communication network 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 110 may be configured with multiple downlink CCs and one or more uplink CCs for carrier aggregation. Carrier aggregation may be used with both FDD and TDD component carriers. The base stations 105 and UEs 110 may use spectrum up to Y MHz (e.g., Y=5, 10, 15, or 20 MHz) bandwidth per carrier allocated in a carrier aggregation of up to a total of Yx MHz (x=number of component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications network 100 may further include base stations 105 operating according to Wi-Fi technology, e.g., Wi-Fi access points, in communication with UEs 110 operating according to Wi-Fi technology, e.g., Wi-Fi stations (STAs) via communication links in an unlicensed frequency spectrum (e.g., 5 GHz). When communicating in an unlicensed frequency spectrum, the STAs and AP may perform a clear channel assessment (CCA) or listen before talk (LBT) procedure prior to communicating in order to determine whether the channel is available.

Additionally, one or more of base stations 105 and/or UEs 110 may operate according to a NR or 5G technology referred to as millimeter wave (mmW or mmwave) technology. For example, mmW technology includes transmissions in mmW frequencies and/or near mmW frequencies. Extremely high frequency (EHF) is part of the radio frequency (RF) in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. For example, the super high frequency (SHF) band extends between 3 GHz and 30 GHz, and may also be referred to as centimeter wave. Communications using the mmW and/or near mmW radio frequency band has extremely high path loss and a short range. As such, base stations 105 and/or UEs 110 operating according to the mmW technology may utilize beamforming in their transmissions to compensate for the extremely high path loss and short range.

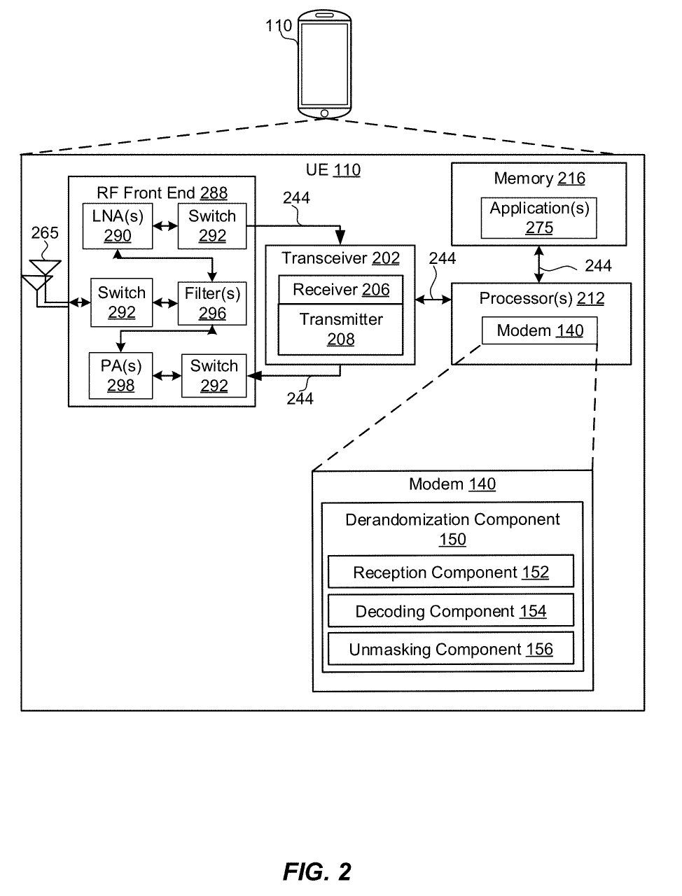

Referring to FIG. 2, one example of an implementation of the UE 110 may include a variety of components, some of which have already been described above, but including components such as one or more processors 212 and memory 216 and transceiver 202 in communication via one or more buses 244, which may operate in conjunction with modem 140 and the derandomization component 150 to enable one or more of the functions described herein related to unmasking the scrambled data stream. Further, the one or more processors 212, modem 140, memory 216, transceiver 202, RF front end 288 and one or more antennas 265, may be configured to support voice and/or data calls (simultaneously or non-simultaneously) in one or more radio access technologies.

In an aspect, the one or more processors 212 may include a modem 140 that uses one or more modem processors. The various functions related to the derandomization component 150 may be included in modem 140 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 140 associated with the derandomization component 150 may be performed by transceiver 202.

Also, memory 216 may be configured to store data used herein and/or local versions of applications 275 or the derandomization component 150 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining the derandomization component 150 and/or one or more of its subcomponents, and/or data associated therewith, when UE 110 is operating at least one processor 212 to execute the derandomization component 150 and/or one or more of its subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 125. Additionally, receiver 206 may process such received signals, and also may obtain measurements of the signals, such as, but not limited to, Ec/Io, SNR, RSRP, RSSI, etc. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one base station 125 or wireless transmissions transmitted by UE 110. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 110 can communicate with, for example, one or more base stations 125 or one or more cells associated with one or more base stations 125. In an aspect, for example, modem 140 can configure transceiver 202 to operate at a specified frequency and power level based on the UE configuration of the UE 110 and the communication protocol used by modem 140.

In an aspect, modem 140 can be a multiband-multimode modem, which can process digital data and communicate with transceiver 202 such that the digital data is sent and received using transceiver 202. In an aspect, modem 140 can be multiband and be configured to support multiple frequency bands for a specific communications protocol. In an aspect, modem 140 can be multimode and be configured to support multiple operating networks and communications protocols. In an aspect, modem 140 can control one or more components of UE 110 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 110 as provided by the network during cell selection and/or cell reselection.

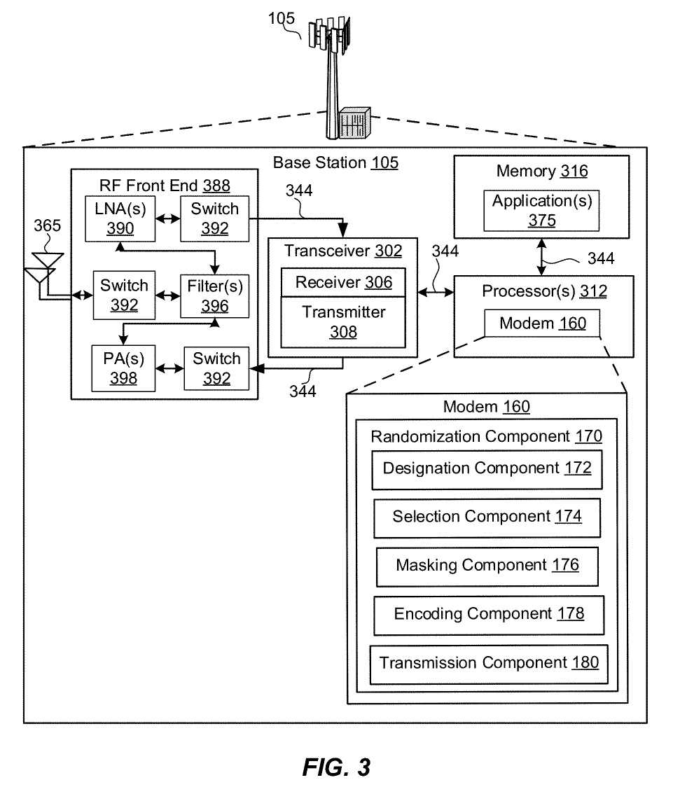

Referring to FIG. 3, one example of an implementation of the UE 110 may include a variety of components, some of which have already been described above, but including components such as one or more processors 312 and memory 316 and transceiver 302 in communication via one or more buses 344, which may operate in conjunction with modem 160 and the derandomization component 170 to enable one or more of the functions described herein related to masking the scrambled data stream. Further, the one or more processors 312, modem 160, memory 316, transceiver 302, RF front end 388 and one or more antennas 365, may be configured to support voice and/or data calls (simultaneously or non-simultaneously) in one or more radio access technologies.

In an aspect, the one or more processors 312 may include a modem 160 that uses one or more modem processors. The various functions related to the randomization component 170 may be included in modem 160 and/or processors 312 and, in an aspect, can be executed by a single processor, while in other aspects, different ones of the functions may be executed by a combination of two or more different processors. For example, in an aspect, the one or more processors 3212 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 160 associated with the randomization component 170 may be performed by transceiver 302.

Also, memory 316 may be configured to store data used herein and/or local versions of applications 375 or the randomization component 170 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining the randomization component 170 and/or one or more of its subcomponents, and/or data associated therewith, when UE 110 is operating at least one processor 312 to execute the randomization component 170 and/or one or more of its subcomponents.

Transceiver 302 may include at least one receiver 3206 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one UE 110 or one BS 105. Additionally, receiver 306 may process such received signals, and also may obtain measurements of the signals, such as, but not limited to, Ec/Io, SNR, RSRP, RSSI, etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 110 may include RF front end 388, which may operate in communication with one or more antennas 365 and transceiver 302 for receiving and transmitting radio transmissions, for example, wireless communications transmitted by at least one base station 105 or wireless transmissions transmitted by UE 110. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 3290 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 298 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that BS 105 can communicate with, for example, one or more UEs 110 or one or more cells associated with one or more base stations 105. In an aspect, for example, modem 160 can configure transceiver 302 to operate at a specified frequency and power level based on the BS configuration of the BS 105 and the communication protocol used by modem 160.

In an aspect, modem 160 can be a multiband-multimode modem, which can process digital data and communicate with transceiver 302 such that the digital data is sent and received using transceiver 302. In an aspect, modem 160 can be multiband and be configured to support multiple frequency bands for a specific communications protocol. In an aspect, modem 340 can be multimode and be configured to support multiple operating networks and communications protocols. In an aspect, modem 160 can control one or more components of BS 105 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on BS configuration information associated with BS 105.

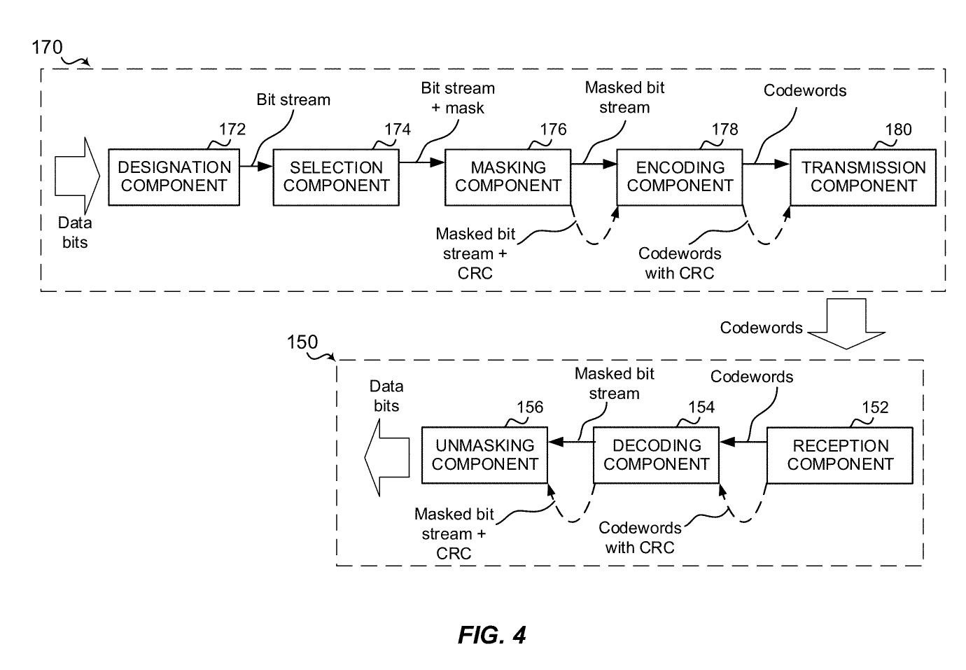

Turning now to FIG. 4, the transmission of masked codeword(s) may be described in further detail with reference to FIGS. 2 and 3. In some implementations, the designation component 172 of the randomization component 170 may designate one or more selected bits within a vector b representing data bits. Here, the vector b≡(b₁, b₂, . . . , b_{N})^{T} denotes the N-bit long column vector of data bits, [symbol] ≡{1, 2, . . . , N} and N*⊂N is a subset of one or more selected bits locations containing |N*|<N bits, where set N* contains the location of the one or more selected bits that will be used to determine data-dependent mask and/or scrambling. Bits at locations in N* will not be masked. Bit selection operator [symbol] returns a vector of bits from locations in N*. Particularly, b*= [symbol] b returns vector b*=(bₙ, n∈N*)^{T} constructed from the selected bits. G denotes the tall generator matrix of the code. That is, c(b)=G·b is the codeword for data bits b. The vector b may include the PBCH payload and the one or more selected bits may include at least one of a SS block index, a half radio frame, and a portion of a System Frame Number (SFN). The portion of the SFN may include a number of least significant bits of the SFN, such as 1, 2, 3, 4, 5, 6, or 7 for example. In other examples, the portion of the SFN may include the nth least significant bit of the SFN, such as the first, second, third, fourth, fifth, sixth, or seventh least significant bit.

In some implementations, the selection component 174 may select a mask sequence that does not alter the values of the selected bits. Mathematically, m(b*)=(m₁, m₂, . . . , m_{N})^{T} may be a b*-dependent N-bit masking sequence such that mₙ=0 for n∈N*. The vector b*= [symbol] b is the vector of the selected bits. The masking sequence may further depend on an ID, denoted as D, such as cell ID, UE ID, or link. Mathematically, the masking sequence may be represented as m(b*, D). With each cell having a unique cell ID, when the UE receives multiple transmissions across two cells with different IDs, even if the locations of the one or more selected bits are identical for each of the multiple transmissions, the masking sequence can still be made distinct by virtue of the dependence on cell ID. The masking sequence may be a pseudo-random sequence, such as a Gold sequence, initialized by seed=nonlinear_function(b*, D). Further, the masking sequence may be obtained from a longer pseudo-random sequence, such as a Gold sequence, initialized by seed=D, and b* used to determine which part of the longer sequence to pick as masking sequence. A high degree of randomness may be expressed as m(b*(1), D(1))+m (b*(1), D(2))≠m (b*(2), D(1))+m (b*(2), D(2)), for D(1)≠D(2) and b*(1)≠b*(2).

In some implementations, the masking component 176 may mask the bit stream containing data bits with the mask sequence that does not modify the one or more selected bits. Optionally, the masking component 176 may mask the bit stream and associated CRC bit(s) with the mask sequence that does not modify the one or more selected bits and/or CRC bit(s). Mathematically, a vector with CRC encoding may be defined as b_{CRC}=G_{CRC}·b, where b includes data bits without the CRC appended. The obtained codeword then is c=G·(b_{CRC}+m(b_{CRC}*)).

In some implementations, the encoding component 178 may encode the masked bit stream. Mathematically, the encoded codeword(s) may be represented as c=G·(b+m(b*)), where G may be an encoding algorithm such as the Polar code generator matrix. Optionally, the encoding component 178 may encode the masked bit stream with additional error detection code such as CRC code. For example, the encoded codeword(s) may be represented as c=G·(b+m(b*)) and G=G_{INNER}G_{OUTER}, where G_{INNER} may be an encoding algorithm and G_{OUTER} may be a CRC code. Mathematically, this is equivalent to scrambling of the codeword where the scrambling of the codeword(s) may be represented as c=G·(b+m(b*))=G·b+G·m(b*)=c(b)+G·m(b*), G·m(b*) being the scrambling sequence that is itself a codeword.

In some implementations, the codeword(s) may be scrambled with a pseudo-random sequence before transmission. The pseudo-random scrambling sequence may depend on an ID, such as cell ID, UE ID, and/or link. The pseudo-random sequence may exclude a valid codeword. For example, the encoded PBCH bits in a SS block may be scrambled based on the cell ID.

The transmission component 180, in some implementations, may transmit the encoded codeword(s). Specifically, the encoded one or more codewords may be transmitted via the antenna 365, the RF front end 388, and/or the transmitter 308 of the base station 105.

Still referring to FIG. 4, in some implementations, the reception component 152 of the derandomization component 150 of the UE 110 may receive the one or more codewords transmitted by the transmission component 180. The one or more codewords may be received via the antenna 265, the RF front end 288, and/or the receiver 206 of the UE 105.

In some implementations, the decoding component 154 decodes the received one or more codewords. Optionally, the decoding component 154 may check the CRC code to detect transmission errors and/or corrupted data.

In some implementations, the unmasking component 156 may determine the masking sequence from the values of the one or more selected bits (i.e., bits at locations in set N*) of the masked bit stream, and then unmasks the masked bit stream to obtain the data bits. Optionally, the unmasking component 156 may use the ID value D (in addition to the one or more selected bits) to determine the masking sequence. Further, the unmasking component 156 may check CRC bits, if present in the unmasked data bits, to verify if data has been received correctly.

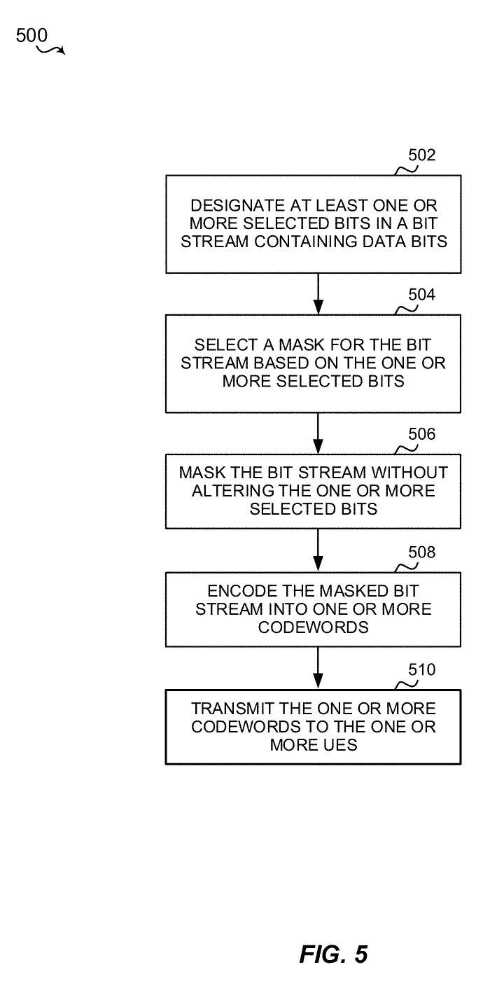

Referring to FIG. 5, with references to FIG. 3, in some implementations, the base station 105 may implement a method 500 for transmitting codewords of masked sequences. At block 502, designate one or more selected bits in a bit stream. For example, the designation component 172 of the base station 105 designates one or more selected bits in the bit stream containing data bits. Data bits may be represented as logic 0's and 1's. The one or more selected bits may remain unaltered during the masking process. The one or more selected bits may be the first n bits of the bit stream, the last n bits of the bit stream, or any subset of bits belonging to the bit stream, where n may be any integer greater than or equal to 1. In one example, the one or more selected bits may be timing bits that change from one transmission to the next transmission in identical manners for two or more cells. In another example, the selected one or more bits may include one or more bits representing system configuration that may remain constant or change over multiple transmission.

At block 504, select a mask for the bit stream based on the one or more selected bits. For example, the selection component 174 of the base station 105 selects a mask among the one or more masks for the bit stream based on the one or more selected bits. In some implementations, the base station 105 may contain one or more masks. Each mask may leave different portions of a bit stream unaltered. The mask may be a series of bits having the same or different number of bits as the bit stream containing data bits. Each mask may correspond to a cell ID, a UE ID, or link. In another example, the randomization component 170 selects a mask that does not alter the one or more selected bits in the bit stream.

At block 506, mask the bit stream without altering the one or more selected bits. For example, the masking component 176 may mask the bit stream containing data bits without altering the one or more selected bits. The masking process may include performing an exclusive or (XOR) operation between the bit stream containing data bits and the mask. For example, for a bit stream (0, 1, 1, 1, 0, 0, 1, 0) with the first and second bits designated as the one or more selected bits (underlined), and a mask sequence of (0, 0, 1, 0, 1, 1, 0, 0), the masking process yields a masked bit stream of (0, 1, 0, 1, 1, 1, 1, 0). The one or more selected bits are unaltered as a result of the masking process. In another example, for a bit stream of (1, 1, 1, 1, 0, 0, 1, 0) with the first and second bits designated as the one or more selected bits, and a mask sequence of (0, 0, 1, 1, 0, 1, 0, 1), the masking process yields a masked bit stream of (1, 1, 0, 0, 0, 1, 1, 1). While the examples show an XOR operation, the masking process may utilize other operators, such as OR, AND, not and (NAND), not or (NOR), exclusive not or (XNOR), and any combination thereof. Further, the masking process may include using more than one mask to convert the bit stream into the masked bit stream.

In some implementations, the masking process may mask the bit stream containing both data bits and optional cyclic redundancy check (CRC) bit(s). The CRC bit(s) improve forward error checking capabilities. If the optional CRC bit(s) are included in the bit stream, the masking component 176 of the base station 105 may select a mask that does not alter the one or more selected bits and the CRC bit(s).

For example, a codeword of [10111011] and a divisor (known to both base station 105 and UE 110) of [1001] may produce CRC bits of [110], which may be appended to the bit stream containing data bits. Upon receiving the codeword and the CRC bits, the masking component 176 of the UE 110 may divide the received codeword by the known divisor [1001]. If the remainder equals to the CRC bits of [110], then there is a high probability that the received codeword contains no error.

At block 508, encode the masked bit stream into one or more codewords. For example, the encoding component 178 of the base station 105 encodes the masked bit stream into one or more codewords. The one or more codewords may be encoded using codes such as Polar code, Turbo code, Convolution code, or any other appropriate codes. During the encoding of the masked bit stream, the encoding component 178 may additionally apply an optional CRC code to the masked bit stream.

In some implementations, the encoding component 178 may optionally scramble the encoded data with a predetermined pseudo-random sequence, such as a Gold Sequence or Goldreich-Goldwasser-Micali Sequence. The pseudo-random sequence may indicate the identities of the base station 105, the cell, the UE 110, and/or link. This pseudo-random sequence may not be a codeword from the code used for communication with the UE 110.

At block 510, transmit one or more codewords. For example, the transmission component 180 of the base station 105 may transmit the one or more encoded codewords, with or without CRC, to the user equipment 110 via one or more wireless communication links 135.

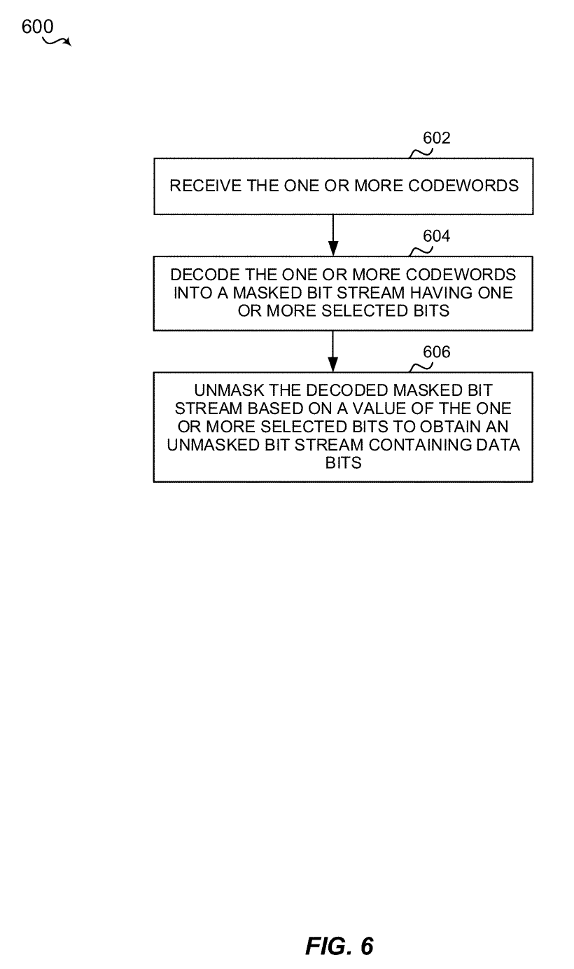

Referring to FIG. 6, a method 600 of decoding codewords may be implemented by the UE 110. At block 602, receive one or more codewords. For example, the reception component 152 of the UE 110 may receive the one or more encoded codewords sent by the base station 105.

At block 604, decode one or more codewords into a masked bit stream. For example, the decoding component 154 of the UE110 may decode the received one or more codewords to obtain the masked bit stream. During the decoding process, the derandomization component 150 may error-check the masked bit stream using the optional CRC code, if encoded by the base station 105. If the CRC code indicates an error in transmission, the UE 110 may request the base station 105 to re-transmit the one or more codewords, discard the corrupted codeword(s), or wait for another transmission.

In some implementations, the decoding component 154 of the UE 110 may optionally unscramble the decoded data using the predetermined pseudo-random sequence. The predetermined pseudo-random sequence may be associated with the base station 105, and received by (or known to) the UE 110 prior to receiving the one or more codewords containing the masked bit stream.

At block 606, unmask the bit stream based on unaltered one or more selected bits. For example, the unmasking component 156 of the derandomization component 150 of the UE 110 may unmask the bit stream based on the unaltered one or more selected bits. Specifically, the masked bit stream may include the one or more selected bits that indicate to the UE 110 the appropriate mask sequence to use in the unmasking process. For example, a masked stream of {0, 1, 0, 1, 1, 1, 1, 0} may include the first and second bits as the selected bits. Given this information, the UE may utilize the mask sequence of {0, 0, 1, 0, 1, 1, 0, 0} and an XOR operation to extract the unmasked bit stream containing data bits from the base station 105. The unmasked sequence may be {0, 1, 1, 1, 0, 0, 1, 0}, which would be identical to the bit stream sent by the base station 105.

If, for example, the base station 105 included CRC bit(s) in the unmasked bit stream, the UE 110 may utilize the CRC bit(s) to check the unmasked bit stream for error. If an error exists, the UE 110 may request the base station 105 to re-transmit the codeword(s), discard the corrupted codeword(s), or wait for another transmission.

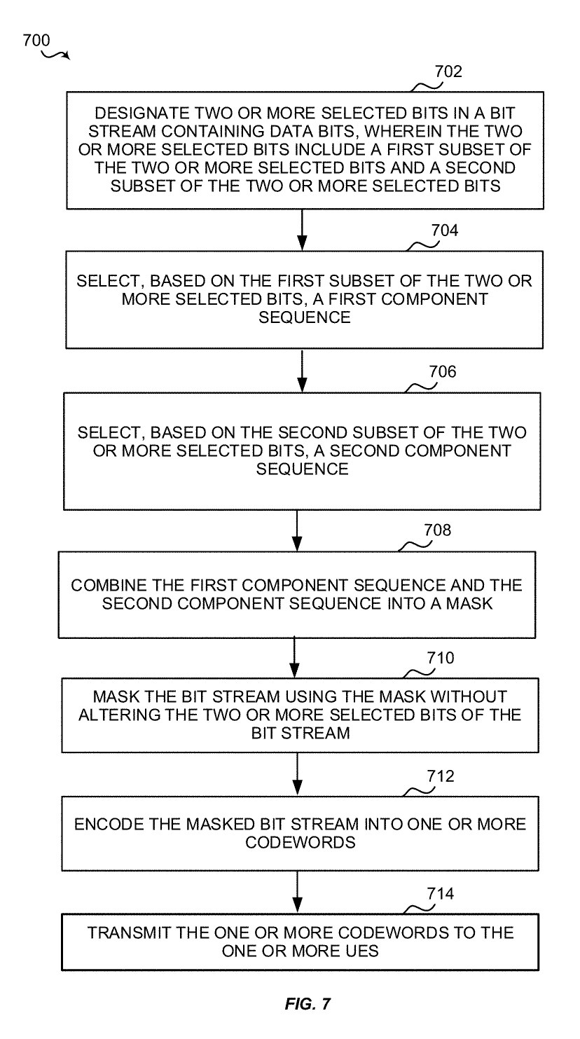

FIG. 7 illustrates another example method 700 of transmitting masked bits to a UE 110 and/or another base station 105. Since the masking process occurs before the coding process, the receiver (i.e., receiving UE 110 and/or BS 105) may decode valid codewords before initiating the unmasking process. By utilizing two component sequences to construct a masking sequence to mask a bit stream, the UE 110 may be able to perform less blind decode when receiving encoded codewords. In the method 700, two or more bits are designated as the selected bits.

At block 702, designate two or more selected bits in a bit stream containing data bits, wherein the two or more selected bits include a first subset of the two or more selected bits and a second subset of the two or more selected bits. For example, the designation component 172 of the base station 105 designates two or more selected bits in the bit stream containing data bits. The two or more selected bits may remain unaltered during the masking process. The two or more selected bits may be the first n bits of the bit stream, the last n bits of the bit stream, or any subset of bits belonging to the bit stream, where n may be any integer greater than or equal to 1. In one example, the two or more selected bits may be timing bits that change from one transmission to the next transmission in identical manners for two or more cells. In another example, the selected two or more bits may include one or more bits representing system configuration that may remain constant or change over multiple transmission. The two or more selected bits include a first subset of the two or more selected bits and a second subset of the two or more selected bits. In some implementations, the first subset and the second subset of the two or more selected bits include no overlapping bits. In other implementations, the first subset and the second subset of the two or more selected bits include some overlapping bits.

At block 704, select, based on the first subset of the two or more selected bits, a first component sequence. For example, the selection component 174 of the base station 105 selects, based on the first subset of the two or more selected bits, a first component sequence. The first subset of the two or more selected bits may include a first subset of the selected bits. The first component sequence may be a series of bits having the same or different number of bits as the bit stream containing data bits. In an example, the selection component 174 may select a first component sequence based on the first subset of the two or more selected bits, and a cell ID, a UE ID, or a link ID.

At block 706, select, based on the second subset of the two or more selected bits, a second component sequence. For example, the selection component 174 of the base station 105 selects, based on a second subset of the two or more selected bits, a second component sequence. The second subset of the two or more selected bits may include a second subset of the selected bits. The second component sequence may be a series of bits having the same or different number of bits as the bit stream containing data bits. The first subset of the two or more selected bits may be same or different than the second subset of the two or more selected bits. In an example, the selection component 174 may select a second component sequence based on the second subset of the two or more selected bits, and a cell ID, a UE ID, or a link ID.

At block 708, combine the first component sequence and the second component sequence into a mask. For example, the masking component 176 may combine the first component sequence and the second component sequence into a mask. In some examples, the masking component 176 may combine the first and second component sequences using an XOR operation. Alternatively, the masking component 176 may utilize other operators, such as OR, AND, NAND, NOR, XNOR, and any combination thereof.

At block 710, mask the bit stream using the mask without altering the two or more selected bits of the bit stream. For example, the masking component 176 may mask the bit stream containing the data bits using the mask without altering the two or more selected bits of the bit stream. In some implementations, the masking component 176 may mask the bit stream while ensuring that the values of the selected bits do not change. For example, two or more selected bits of (0, 1, 0) may remain (0, 1, 0) after the masking step. The masking process may include performing an XOR operation between the bit stream containing data bits and the mask. The masking component 176 may also utilize other operators, such as OR, AND, NAND, NOR, XNOR, and any combination thereof.

In some implementations, masking the bit stream without altering the two or more selected bits may be achieved when the bits in the first component sequence having the same bit positions as the two or more selected bits are identical to the bits in the second component sequence having the same bit positions as the two or more selected bits. In a non-limiting example, a bit stream of (0, 0, 1, 1, 1, 0, 0, 0, 0, 1) may have the three least significant bits as the selected bits (underlined), namely 0, 0, 1. The method 700 may select 704, 706 a first component sequence of (1, 0, 1, 0, 1, 0, 1, 1, 0, 1) and a second component sequence of (1, 1, 0, 0, 1, 1, 0, 1, 0, 1). The three least significant bits of the first component sequence (i.e. 1, 0, 1) may be identical to the three least significant bits of the second component sequence (i.e. 1, 0, 1). The method 700 may combine 708 the first and the second component sequences using an XOR operation to generate a mask of (0, 1, 1, 0, 0, 1, 1, 0, 0, 0). The method 700 may mask 710 the bit stream (0, 0, 1, 1, 1, 0, 0, 0, 0, 1) with the mask of (0, 1, 1, 0, 0, 1, 1, 0, 0, 0) using an XOR operation to generate a masked bit stream of (0, 1, 0, 1, 1, 1, 1, 0, 0, 1) without altering the selected bits (i.e. 0, 0, 1) of the bit stream.

In other implementations, if a 20 bits-long bit stream includes the 9th, 10th, 11th, and 12th bits as the selected bits, the method 700 may select 704, 706 a first and a second component sequences (both 20 bits-long) such that the 9th, 10th, 11th, and 12th bits of the first component sequence may be identical to the 9th, 10th, 11th, and 12th bits of the second component sequence. The method 700 may combine 708 the first and the second component sequences with an XOR operation and mask 710 the bit stream using the mask with another XOR operation. The 9th, 10th, 11th, and 12th bits of the bit stream may be unaltered from the masking process.

In certain examples, if a 30 bits-long bit stream includes the 13th, 14th, 15th, 16th, and 17th bits as the selected bits, the method 700 may select 704, 706 a first and a second component sequences (both 30 bits-long) such that the 13th, 14th, 15th, 16th, and 17th bits of the first component sequence may be the corresponding logic complements/negations to the 13th, 14th, 15th, 16th, and 17th bits of the second component sequence. The method 700 may combine 708 the first and the second component sequences with an XNOR operation and mask 710 the bit stream using the mask with an XOR operation. The 13th, 14th, 15th, 16th, and 17th bits of the bit stream may be unaltered from the masking process.

In other examples, if the bits of the mask having the same bit positions as the selected bits of the bit stream are all 1's, the method 700 may mask the bit stream using an XNOR operation so the selected bits remain unaltered.

In some implementations, the masking process may mask the bit stream containing both the data bits and optional cyclic redundancy check (CRC) bit(s). The CRC bit(s) improve forward error checking capabilities. If the optional CRC bit(s) are included in the bit stream, the masking component 176 of the base station 105 may use a mask that does not alter the two or more selected bits and the CRC bit(s).

At 712, encode the masked bit stream into one or more codewords. For example, the encoding component 178 of the base station 105 encodes the masked bit stream into one or more codewords. The one or more codewords may be encoded using codes such as Polar code, Turbo code, Convolution code, or any other appropriate codes. During the encoding of the masked bit stream, the encoding component 178 may additionally apply an optional CRC code to the masked bit stream.

In some implementations, the encoding component 178 may optionally scramble the encoded data with a predetermined pseudo-random sequence, such as a Gold Sequence or Goldreich-Goldwasser-Micali Sequence. The pseudo-random sequence may indicate the ID's of the base station 105, the cell, the UE 110, and/or link. This pseudo-random sequence may not be a codeword from the code used for communication with the UE 110.

At block 714, transmit the one or more codewords to the one or more UEs. For example, after encoding the masked bits, the transmission component 180 of the base station 105 may transmit the one or more encoded codewords, with or without CRC, to the user equipment 110 via one or more wireless communication links 135.

In certain implementations, the UE 105 may require less blind decoding to decode the one or more encoded codewords transmitted at block 714. The UE 105 may rely on the method 600 to decode the one or more encoded codewords transmitted at block 714.

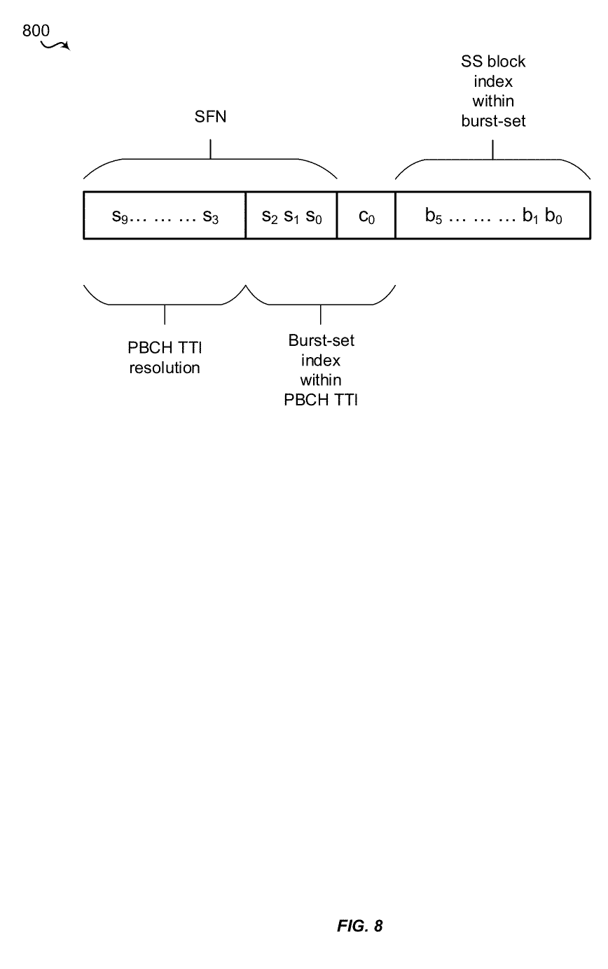

FIG. 8 illustrates an example of timing information bitfields 800. Bits s₉ . . . s₀ denote the sub-frame number (SFN), and there may be 8 frames in one broadcast channel (BCH) time transmission interval (TTI). Bits s₉ . . . s₀ may not change within a BCH TTI, while the 3 least significant bits of SFN s₂, s₁, s₀ may change within BCH TTI and may be seen as a frame index (0, 1, . . . , 7) within a BCH TTI. By designating b⁽¹⁾*=(s₂, s₁), and b⁽²⁾*=(s₀), the mask may be m(s₂, s₁, s₀; D)=m⁽¹⁾(s₂, s₁; D)+m⁽²⁾(s₀; D).

In another example, a seed cᵢₙᵢₜ=D may be used to generate 6M bits long sequence (e.g. Gold sequence), c=(c₀, c₁, . . . , c_{6M-1}), and cut it in six parts, c(ⁱ)=(c_{Mi}, . . . , cₘ₍ᵢ₊₁₎₋₁), for i∈{0, 1, . . . , 5}. The M bit long masking sequence may be described as m(s₂, s₁, s₀; D)=c^{(2s}^{₂}^{+s}^{₁}⁺²⁾+c^{(s}^{₀}⁾.

In other examples, the selected bits may be divided into K≥2 components, denoted b^{(k)}* for kœ{1, 2, . . . , K}. The k^{th} component sequence may be generated based on the k^{th} selected bits component b^{(k)}* and ID D, with the k^{th} component sequence denoted by m^{(k)}(b^{(k)}*, D) for k∈{1, 2, . . . , K}. The masking sequence m(b*, D) may be generated by applying an xor function to the K component sequences, i.e., m(b*,D)=m⁽¹⁾(b⁽¹⁾*,D)+m⁽²⁾(b⁽²⁾*,D)+ . . . +m^{(K)}(b^{(K)}*,D). As indicated above, the masking sequence is 0 at selected bit locations: mₙ^{(k)}=0 for n∈N* and all k∈{1, 2, . . . , K}.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

1. A method of receiving one or more codewords from a base station, comprising:
receiving the one or more codewords;
decoding the one or more codewords into a masked bit stream having one or more selected bits; and
unmasking the decoded masked bit stream based on a value of the one or more selected bits to obtain an unmasked bit stream containing data bits.

2. The method of claim 1, further comprising:
checking for an existence of an error in the masked bit stream based on a cyclic redundancy check code.

3. The method of claim 1, further comprising:
checking for an existence of an error in the data bits using one or more cyclic redundancy check bits appended to the unmasked bit stream.

4. The method of claim 1, further comprising:
unscrambling the one or more codewords after receiving the one or more codewords.

5. The method of claim 1, wherein the unmasked bit stream includes a Physical Broadcast Channel payload.

6. The method of claim 1, wherein the one or more selected bits include at least a synchronization signal block index, a half radio frame, and a portion of a System Frame Number.

7. The method of claim 6, wherein the portion of the System Frame Number includes one or more least significant bits of the System Frame Number.

8. A user equipment, comprising:
a transceiver;
a memory; and
one or more processors in communication with the transceiver and the memory, wherein the one or more processors are configured to:
receive, via the transceiver, one or more codewords from a base station;
decode the one or more codewords into a masked bit stream having at least one or more selected bits; and
unmask the masked bit stream based on a value of the one or more selected bits to obtain an unmasked bit stream containing data bits.

9. The user equipment of claim 8, wherein the one or more processors are further configured to check for an existence of an error in the masked bit stream based on a cyclic redundancy check code.

10. The user equipment of claim 8, wherein the one or more processors are further configured to check for an existence of an error in the data bits using one or more cyclic redundancy check bits appended to the unmasked bit stream.

11. The user equipment of claim 8, wherein the one or more processors are further configured to unscramble the codeword after reception.

12. The user equipment of claim 8, wherein the unmasked bit stream includes a Physical Broadcast Channel payload.

13. The user equipment of claim 8, wherein the one or more selected bits include at least a synchronization signal block index, a half radio frame, and a portion of a System Frame Number.

14. The user equipment of claim 13, wherein the portion of the System Frame Number includes one or more least significant bits of the System Frame Number.

15. A computer-readable medium storing computer code stored therein that, when executed by one or more processors for wireless communications, cause the one or more processors to:
receive one or more codewords from a base station;
decode the one or more codewords into a masked bit stream having at least one or more selected bits; and
unmask the masked bit stream based on a value of the one or more selected bits to obtain an unmasked bit stream containing data bits.

16. The computer-readable medium of claim 15, further comprising instructions that, when executed by the one or more processors for wireless communications, cause the one or more processors to check for an existence of error in the masked bit stream based on a cyclic redundancy check code.

17. The computer-readable medium of claim 15, further comprising instructions that, when executed by the one or more processors for wireless communications, cause the one or more processors to check for an existence of error in the data bits using one or more cyclic redundancy check bits appended to the unmasked bit stream.

18. The computer-readable medium of claim 15, further comprising instructions that, when executed by the one or more processors for wireless communications, cause the one or more processors to unscramble the codeword after reception.

19. The computer-readable medium of claim 15, wherein the unmasked bit stream includes a Physical Broadcast Channel payload.

20. The computer-readable medium of claim 15, wherein the one or more selected bits include at least a synchronization signal block index, a half radio frame, and a portion of a System Frame Number.

21. The computer-readable medium of claim 20, wherein the portion of the System Frame Number includes one or more least significant bits of the System Frame Number.

22. A method of transmitting masked data from a base station to one or more UEs, comprising:
designating at least one or more selected bits in a bit stream containing data bits;
selecting a mask for the bit stream based on the one or more selected bits;
masking the bit stream without altering the one or more selected bits;
encoding the masked bit stream into one or more codewords; and
transmitting the one or more codewords to the one or more UEs.

23. The method of claim 22, wherein the selecting the mask further includes selecting the mask based on an ID selected from one of a cell ID, a UE ID, and a link ID.

24. The method of claim 22, wherein the bit stream includes a Physical Broadcast Channel payload.

25. The method of claim 22, further comprising encoding the masked bit stream using a cyclic redundancy check code.

26. The method of claim 22, wherein the one or more selected bits include at least a synchronization signal block index, a half radio frame, and a portion of a System Frame Number.

27. The method of claim 22, further comprising scrambling the one or more codewords prior to transmission.

28. The method of claim 27, wherein scrambling the one or more codewords includes scrambling with a pseudo-random sequence based on an ID of the UE, a cell of the base station, or a link ID.

29. The method of claim 22, wherein the mask is a Gold sequence.

30. A base station, comprising:
a transceiver;
a memory; and
one or more processors in communication with the transceiver and the memory, wherein the one or more processors are configured to:
designate at least one or more selected bits in a bit stream containing data bits;
select a mask for the bit stream based on the one or more selected bits;
mask the bit stream without altering the one or more selected bits;
encode the masked bit stream into one or more codewords; and
transmit, via the transceiver, the one or more codewords to the one or more UEs.

31. The base station of claim 31, wherein the selecting the mask further includes selecting the mask based on an ID selected from one of a cell ID, a UE ID, and a link ID.

32. The base station of claim 31, wherein the bit stream includes a Physical Broadcast Channel payload.

33. The base station of claim 31, wherein the one or more processors are configured to encode the masked bit stream using a cyclic redundancy check code.

34. The base station of claim 31, wherein the one or more selected bits include at least a synchronization signal block index, a half radio frame, and a portion of a System Frame Number.

35. The base station of claim 31, wherein the one or more processors are configured to scramble the one or more codewords prior to transmission.

36. The base station of claim 35, wherein scrambling the one or more codewords includes scrambling with a pseudo-random sequence based on an ID of the UE, a cell of the base station, or a link ID.

37. The base station of claim 31, wherein the mask is a Gold sequence.
